(19) United States
(12) Patent Application Publication
(10) Pub. No.: US 2008/0117099 A1
(43) Pub. Date: May 22, 2008

(54) Radar System Including a Heterodyne Mixer for the Improved Detection of Short-Range Signals

(76) Inventors: Thomas Walter, Renningen (DE); Juergen Hildebrandt, Weilheim (DE); Joachim Hauk, Renningen-Malmsheim (DE); Martin Reiche, Weil Der Stadt (DE)

Correspondence Address: KENYON & KENYON LLP, ONE BROADWAY, NEW YORK, NY, 10004, US

(21) Appl. No.: 11/663,715

(22) PCT Filed: Aug. 3, 2005
(86) PCT No.: PCT/EP05/53816

§ 371 Date: Mar. 22, 2007

(30) Foreign Application Priority Data
Mar. 25, 2004 (DE) 102004046632.7

(51) Int. Cl. G01S 13/00

(52) U.S. Cl. 342/25 R

(57) ABSTRACT

In an antenna radar system including a short-range antenna path and a long-range antenna path that is situated separately from the short-range antenna path, a push-pull mixer is situated in the short-range antenna path. Using the push-pull mixer, a heterodyne frequency conversion or mixing of the signals to be processed is able to be carried out in the short-range antenna path.

### FIELD OF THE INVENTION

The present invention relates to an antenna radar system which may be used in automobile technology, as well as a method for its operation.

### BACKGROUND INFORMATION

In motor vehicle technology, up to now, almost exclusively long range radar (LRR) systems have been used for the long-range recording of detection targets. However, in that field, too, there is an increasing requirement for using short range radar (SRR) systems having short range detection, for instance, for carrying out clearance measurements in vehicle columns (automatic drive off in bumper to bumper driving or the like) or for use as a parking aid.

In general, the detection field for short-range applications has a substantially greater opening angle in comparison to long-range applications. But because of smaller so-called EIRP values in the short-range applications, the latter also have a shorter range. The EIRP (equivalent isotropic radiated power) value mentioned represents a pure operand, and tells how great a transmission power one would have to supply an antenna that radiates in all spatial directions isotropically, in order to achieve the same power flow density in the long-range field as would be the case using a bundling directional antenna in its main transmit direction. For these reasons, it is almost impossible to provide a common antenna aperture for the LRR and the SRR function.

In the antenna radar systems known from the related art, that are suitable for the automotive field, the incoming signal is frequency-translated downwards (“down converted”) in homodyne fashion, using an unbalanced one-diode converter (mixer). This causes noise in the amplitude-modulated output signal, whereby, as a result, the sensitivity of the radar system to objects at a short distance are considerably limited.

Besides that, antenna radar systems already being used outside of automotive technology, that are optimized towards short-range recording or detection, only achieve a minimum measuring distance of 0.5 m, at this time. However, in the above-mentioned driving situations (bumper to bumper traffic, etc.), as short as possible a minimum measuring distance, in the range of a few decimeters, is desirable.

### SUMMARY OF THE INVENTION

Therefore, an object of the exemplary embodiment and/or exemplary method of the present invention is based on further developing the antenna radar system of the type described at the outset in such a way that the short-range weakness described for the known systems is removed. However, this further development should be oriented, if possible, towards existing antenna radar systems, in order to keep development costs and manufacturing costs as low as possible.

The exemplary embodiment and/or exemplary method of the present invention involves providing a push-pull mixer, in an antenna radar system discussed here, in a short-range antenna path, which utilizes the same or at least a very similar intermediate frequency as is provided, as is well known, for a phase lock loop (PLL).

The antenna radar system proposed according to the exemplary embodiment and/or exemplary method of the present invention can be operated, using the push-pull mixer in the short range using heterodyne mixing, the frequency offsets of potential detection targets coming to lie far outside the phase noise of a local oscillator (LO) situated in the short-range antenna path, and the amplitude modulated noise (AM noise) in the LO path is suppressed.

Thus, the push-pull mixer suppresses the amplitude modulation noise that is mostly present in the LO path, which is automatically mixed together with the carrier frequency of the transmit signal in sidebands situated around the intermediate frequency. As is well known, the carrier frequency itself does not vary in its amplitude in response to amplitude-modulated signals. Rather, the modulation occurs in the form of signal components having frequencies somewhat above and below the carrier frequency, which signal components are generally designated as “sidebands”.

As a result, using the exemplary embodiment and/or exemplary method of the present invention, short-range measurements having a resolution of a few decimeters are made possible.

In one embodiment, the LO of the push-pull mixer is fed with the fourth (4th) harmonic of a reference oscillator; however, instead of using the fourth harmonic, two frequency doublers may also be provided, which has the additional advantage that a maximum LO power can be held in reserve for the push-pull mixer.

In the automotive field, in the radar systems discussed here, monostatic antennas are mostly used in which the irradiated and radiated signals (so-called “RX/TX feeds”) use a common aerial lens. The polarization axes of these two signals mostly have an angle of 45° in the radar systems mentioned, in order to ensure that the signals, coming from an approaching vehicle equipped with the same radar, are received cross-polarized with respect to one's own receive signal. Based on this measure, disturbing interferences between the signals of the two vehicles are effectively suppressed. The antenna radar system according to the exemplary embodiment and/or exemplary method of the present invention can be designed for this purpose in such a way that the apertures of the long-range and the short-range functions are operated cross-polarized, a timed multiplexer of long-range and short-range mode being implemented using switchable transmit preamplifiers in the transmit path of the long-range and short-range radar functions. For, based on the antenna characteristics known per se of radar antennas, that is, the predefined primary and secondary lobes in the radiation and irradiation characteristics, without the measures that were mentioned, there would be a crossfeed (coupling) between these two functions. Based on the cross-polarization for the short-range and the long-range functions, an extremely effective decoupling is achieved between these two functions, so that these functions are able to be integrated, without trouble, into a single antenna radar system.

Using the proposed heterodyne frequency translation (mixing), an existing, predominantly long-range antenna radar system (LRR) can be upgraded by a high-resolution short-range detection, in order, for instance, to make available a combination system for both the short range and the long range.

The antenna radar according to the exemplary embodiment and/or exemplary method of the present invention, having the advantages mentioned, can also be used in bistatic antennas which, as is well known, have separate transmit and receive paths. Even based on this path separation, a cross feed of the transmit signal into the receiver is minimized.

### BRIEF DESCRIPTION OF THE DRAWINGS

FIG. 1 shows a basic representation of a receive circuit having heterodyne detection, according to the related art.

FIGS. 2a and 2b show an overview representation of frequencies occurring basically in response to down converters and up converters using a converter shown in FIG. 1.

FIG. 3 shows an electronic circuit diagram of an exemplary embodiment of the antenna radar system according to the exemplary embodiment and/or exemplary method of the present invention.

FIGS. 4a and 4b show “typical” signal patterns in the time range of a one diode converter (a) and a push-pull mixer (b) in comparison.

FIG. 5 shows a transmit power mask of a combination LRR-SRR sensor according to the exemplary embodiment and/or exemplary method of the present invention.

### DETAILED DESCRIPTION

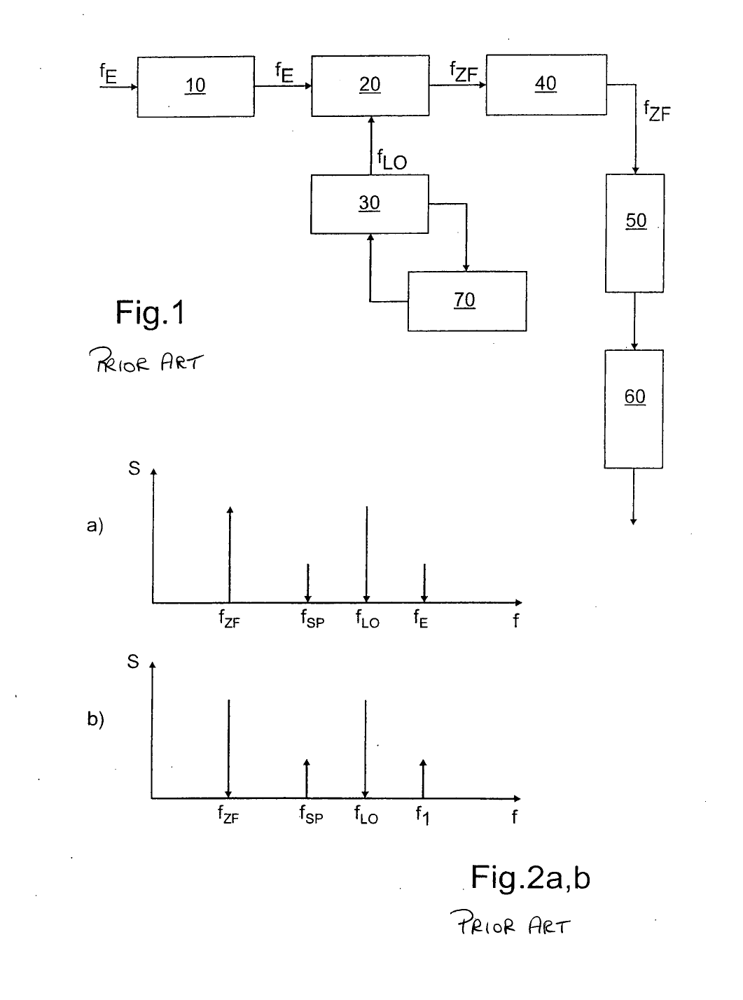

As in available high frequency (HF) transmit/receive technology, for instance, messaging technology, the antenna radar systems included here, in order to make possible the reception of very short wavelengths, which, in turn, has connected with it relatively high location resolution, have a phase lock loop “PLL” 70, which is modulated by a digital divider N, and which has available to it an integrated voltage-controlled oscillator (VCO) which is used for generating a carrier signal. As can be seen in FIG. 1, the VCO functions as a so-called local oscillator for converter 20, for instance, for the receiver, which mixes or down converts high frequency receive signal f_E to a lower intermediate frequency f_ZF. This principle of the frequency conversion or down conversion has been used for many decades in radio receivers.

In the signal receiving detectors mentioned, one distinguishes, as is well known, between a direct detection and a heterodyne detection. In the direct detection, an incoming receive signal is directly processed further, whereas in heterodyne detection an additional signal f_LO, fed in by a local oscillator (LO) 30, is overlaid on receive signal f_E. These two frequencies are mixed in order to obtain the intermediate frequency (f_ZF) that was mentioned. Intermediate frequency f_ZF is in a frequency range which is easy to amplify and which makes possible the use of frequency selection circuits having in each case the desired bandwidth. Such a heterodyne receiver is shown schematically in FIG. 1.

Normally, the intermediate frequency is predefined in a fixed manner, and only oscillator 30 and input circuit 10 are tuned to each other. The crux of the circuit is mixer stage 20, in which receive signal f_E is overlaid with oscillator frequency f_LO. If one were to fit in a frequency-independent resistor at the output of mixer stage 20, the four following different frequencies would result:
a. input frequency f_E
b. oscillator frequency f_LO
c. frequency sum f_E+f_LO, and
d. difference frequency f_LO−f_E (=intermediate frequency f_ZF).

Generally, only intermediate frequency f_ZF is of interest, and therefore one connects a bandfilter 40, that is tuned to f_ZF, to the output line of mixer stage 20. From there, it goes for further amplification and selection to a post-connected intermediate frequency amplifier 50 and a detector 60, that is, in turn, post-connected to the latter, used for the final demodulation of the amplitude-modulated input signal.

Accordingly, using the heterodyne receiver shown schematically in FIG. 1, input signal f_E is converted or mixed, before the demodulation, to the fixed intermediate frequency f_ZF using converter 20. Correspondingly, on the transmit side (not shown here) the modulation is often carried out, not at the transmit frequency, but also at a smaller intermediate frequency, and the signal thus created is increased to the desired transmit frequency. The necessary heterodyne frequency, in this context, is also supplied by a VCO which, for instance, covers a frequency range of 300 to 458 MHz.

The above-described frequency conversion either takes place using “up converters” or using “down converters”, depending on whether the desired output signal is to lie above or below the input signal. Such a converter basically represents a three-port junction having inputs for input frequency f_E and local oscillator frequency f_LO, as well as an output for intermediate frequency f_ZF, the mixing representing a nonlinear process in which at least two of the variables named are multiplied by each other. An ideal converter, between ports ‘E’ and ‘ZF’ behaves like an adapted, lossy two-port, which simply additionally undertakes a frequency shift. At input ‘LO’ the local oscillator signal is supplied having the frequency f_LO, which determines the difference between f_E and f_ZF and which, as a rule, is substantially stronger than the two other signals. For the connection between the three frequencies mentioned, F_ZF=±(f_E−f_LO) applies.

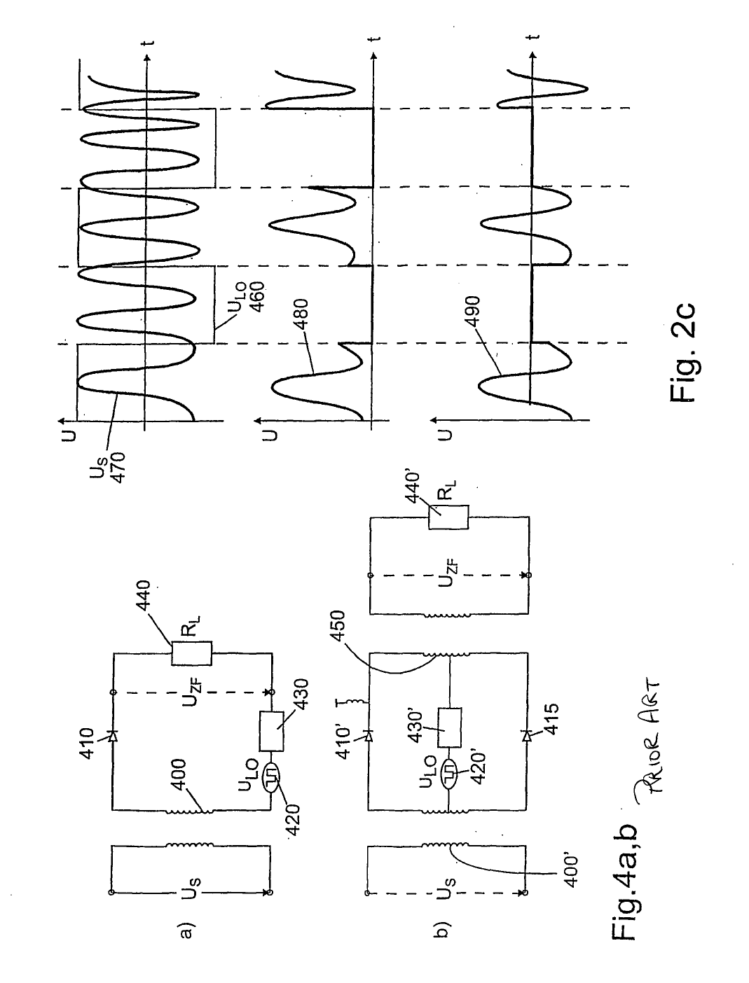

In a down converter, the input signal, having a frequency f_E, has a higher frequency than that of the desired output signal, f_ZF. Depending on whether f_E is greater or smaller an f_LO, the positive or negative sign applies in the above equation. The connection between these three frequencies are shown in FIGS. 2a and 2b. FIG. 2a shows the frequencies occurring at a down converter, while FIG. 2b includes the frequencies coming about at an up converter. The arrows pointing down correspond to input signals, whereas the arrows pointing up represent output signals.

Besides the desired output frequency f1, there also especially occurs the so-called “image frequency” f_SP, which has a frequency of f_SP=f_LO−f_ZF (see FIG. 2b).

The meaning of the image frequency (in FIG. 2c) is that an external signal having the image frequency, in the case of a given local oscillator frequency, is converted (mixed) into the same intermediate frequency f_ZF as the desired input signal of frequency f_E. Therefore, the image frequency is mostly filtered out using a suitable input filter. The interfering “image frequency” f_SP represents a second receive possibility that is situated as a mirror image (at a distance of the intermediate frequency) from the oscillator frequency and is mostly undesired. Accordingly, the relationship f_SP=f_E−(2*f_ZF) applies for image frequency f_SP.

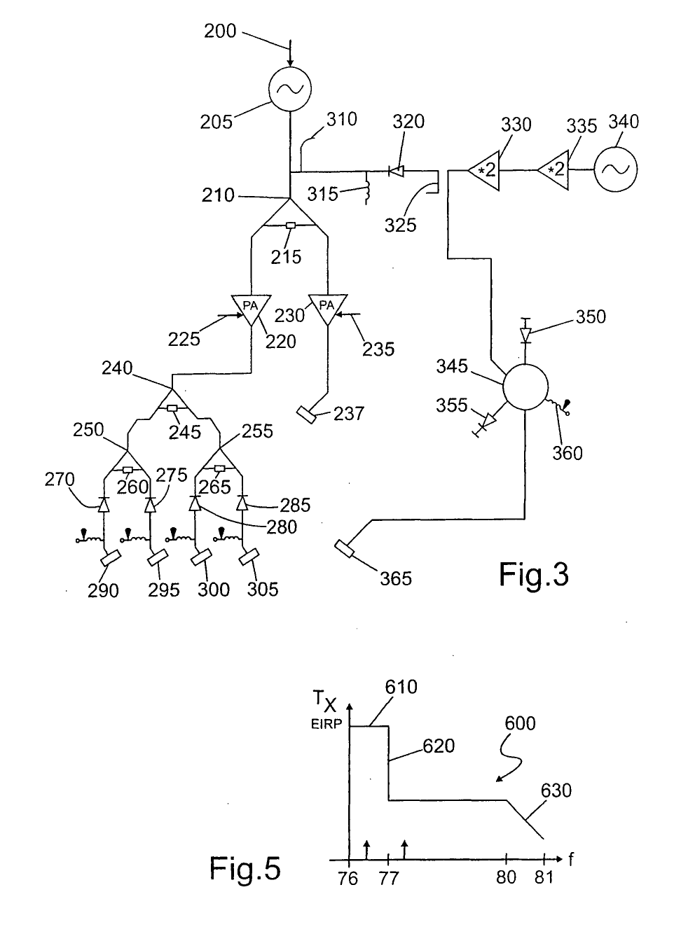

The antenna radar system according to the exemplary embodiment and/or exemplary method of the present invention shown in FIG. 3 at the same time includes a long-range (LRR) function included in reference numerals 210-305 and a short-range (SRR) function included in reference numerals 310-365 and reference numerals 230 and 237. LRR function 210-305 and SRR function 310-365 are operated synchronously in the present exemplary embodiment, that is, not in timed multiplex operation using a change-over switch, multiplexers or the like. However, it should be noted that the exemplary embodiment and/or exemplary method of the present invention can basically also be used in that type of timed multiplex systems.

The synchronous operation mentioned is only possible, without interference of the two functions with each other, because between the SRR functions and the LRR functions in this exemplary embodiment, a cross polarization occurs, which has the effect of a sufficient signal technology insulation between the two functions. In the cross polarization, the polarized signals of the SRR function and the LRR function are operated in a manner known per se, polarized perpendicularly to each other, whereby it is prevented in many situations that the signals are able to be superposed at all, constructively or destructively.

The feeds indicated only schematically in FIG. 3, i.e. Tx/Rx feed 290-305 of the LRR function as-well as the Tx feed supplied via a first patch antenna 237 and the Rx feed of the SRR function supplied via a second patch antenna 365, which make available the actual transmit/receive function of the monostatic antenna, are each formed by a previously described “patch array” that is not shown in FIG. 3. The Tx feed supplied via first patch antenna 237 reaches a preamplifier 230 supplied with a bias voltage 235.

With regard to the patch arrays, one should note that their technical details are not important in the present connection. Such a patch array for a high frequency antenna is described in detail, for example, in the simultaneously filed Patent Application (having Application file number R. 307998), to which we make full reference in this connection. The feeds mentioned, 290-305, 237 and 365 are situated spatially separated from one another for the reasons named.

The circuit shown in FIG. 3 will now be described in a detailed manner. First of all, we shall describe the short-range antenna path (SRR patch) 310-365.

An input signal 200 supplied by a phase lock loop (=PLL) that is not shown is first of all used to operate a voltage-controlled oscillator (VCO) 205. The oscillating signal generated by the VCO (here a transmit VCO) 205 is fed to short-range transmit antenna 237 using a power splitter 210, 215. This input signal 200 is supplied to a converter 320, which may use capacitive coupling element 310, and its input signal, in turn, originates with a source 340. To do this, the fourth harmonic of a stable reference oscillator 340, which, in the current exemplary embodiment, oscillates at a frequency of 4*18.65 GHz=74.6 GHz, and which, in the present instance, oscillates at a frequency of 76.5 GHz±125 MHz, is mixed at a diode 320 that is situated serially in SRR path 310-365. The fourth harmonic mentioned is generated in the present exemplary embodiment from the signal supplied by reference oscillator 340, using two frequency doublers 330, 335 that are connected in series.

As a result, the intermediate frequency yielded in response to the down conversion is in this example at 76.5 GHz−74.6 GHz=1900 MHz. The image frequency that was mentioned, which has a critical effect, as mentioned above, especially in the case of interference signals when these are mixed to the same intermediate frequency, is at 72.7 GHz in the present example.

The frequency generated in 330, 335 and 340 is supplied to a push-pull mixer 345-360. The exact method of functioning of push-pull mixer 345-360 will be described below in greater detail in light of FIGS. 4a and 4b.

Based on the heterodyne down conversion of the intermediate frequency signal, that will also be described below, and the antenna signal supplied via SRR feed 365, the frequency offsets of potential detection targets occur widely outside the phase noise of LO 330, 335 and 340. The phase noise is, for example, mixed by reflection at RX feed 365 in a DC-near frequency range.

The AM noise of LO 330, 335 and 340, on the other hand, is mixed directly by demodulation in the mixer in the DC-near frequency range. The AM suppression takes place in the push-pull mixer by destructive interference based on the different polarity of the two diodes.

In the technical implementation of the exemplary embodiment and/or exemplary method of the present invention, the basic modulation form of known systems can be maintained, whereby one may extensively use existing electronic systems (VCO, PLL, reference StaLO, etc.).

It should further be noted that, in order to achieve the above-mentioned properties in an alternatively possible pulse radar (instead of the present continuous wave radar), in contrast to the design attempt described above, an implementation of rapid switches, their drivers and a highly precise, variable delay electronic system would be required. However, the components mentioned are very costly.

For the down conversion of the signals supplied by VCO 205, long-range antenna path (LRR path) 210-305 has four unbalanced one diode mixers 270-285. Mixer diodes 270-285 lie in each case separately in the path of each Tx/Rx feed 290-305. Mixer diodes 270-285 functionally correspond to switches, in this context, which are opened and closed in the clock pulse of oscillator 205. Via four patch antennas 290-305 also designed as patch arrays, the Tx signals reach a focussing unit (such as a lens) and are radiated from there. The reflected components reach patch antennas 290-305 via the focussing unit, and are mixed into the baseband, using mixer diodes 270-285. The lower frequency ZF signal, yielded by the down conversion using mixer diodes 270-285, is then supplied, in turn, via a TP structure 240-265, that is post-connected to patch antennas 290-305 and mixer diodes 270-285 and brings together the entire received power, to a second preamplifier 220 that is provided with a bias voltage 225.

FIGS. 4a and 4b illustrate the method of functioning of a one diode mixer (FIG. 4a) and a push-pull mixer (FIG. 4b) in a direct comparison. For the sake of simplicity, respectively corresponding components are provided with corresponding reference numerals devised above.

As may be seen in FIG. 4a, an AC voltage U_S applied at the input is first of all stepped up or stepped down using a transformer coil 400 (or 400′), depending on the application. In the upper line branch there is a (mixer) diode 410, whereas on the lower line branch there are situated both a local oscillator (LO) 420 and a resistor 430 that is postconnected to the LO. Because of the superposition, already described, of input signal U_S and oscillator signal U_LO, a voltage U_ZF oscillating at intermediate frequency ZF decays over a load resistance R_L 440 that is situated at the output. Oscillator signal U_LO modulates diode 410 periodically, nonlinearly. Input signal U_S sees in diode 410 a linear network periodically changeable in time, that is, LO 420 “pumps” diode 410.

As may be seen in FIG. 4b, by contrast to the one diode mixer, the push-pull mixer has two symmetrically connected (i.e. balanced) diodes 410′, 415, which are modulated by an LO 420′ in the same direction. LO 420′ and a resistor 430′ assigned to it, in turn, are, in this context, situated on an additional line branch that is situated symmetrically (centrically) with respect to the upper and the lower line branch. The insulation achieved thereby between LO 420′ and ZF suppresses the LO noise at the ZF port.

The right half of FIG. 4 shows typical output voltage curves that come about in response to the two converters. In this context, the upper diagram shows the voltage curves of the specified signals U_S 470 and U_LO 460. In the left half of FIG. 4 the upper diagram shows the circuit diagram known per se of a one diode mixer, and the lower diagram shows the circuit diagram of a push-pull mixer that is also known per se.

FIG. 5 shows a transmit power mask (EIRP plotted against frequency) for the long range having frequencies of 76-77 GHz as well as the short range having frequencies of 79-81. Objects at a minimum distance of approximately 100-200 m are able to be measured using known antenna radar systems. In this range, the greatest sensitivity of the system must be ensured. In response to a ramp duration of, for instance, Δt=5 ms, and a frequency deviation of Δf=250 MHz, there would come about, with an assumed static detection target (i.e. without a Doppler shift) and at a distance of 100 m, a frequency offset in the homodyne intermediate frequency band of f_{ZF}=2*100 m*Δf/Δt/c=33 kHz.

1-13. (canceled)

14. An antenna radar system comprising:
a short-range antenna path;
a long-range antenna path situated separately from the short-range antenna path; and
a push-pull mixer situated in the short-range antenna path.

15. The antenna radar system of claim 13, wherein the push-pull mixer is coupled to a local oscillator, and wherein two frequency doublers are coupled in series and situated between the push-pull mixer and the local oscillator.

16. The antenna radar system of claim 13, wherein the push-pull mixer is fed with the fourth harmonic of a reference frequency of about 18.65 GHz from a reference oscillator.

17. The antenna radar system if claim 16, wherein the reference frequency for mixing the intermediate frequency in the short-range antenna path is generated using a converter.

18. The antenna radar system of claim 17, wherein the converter supplies a second phase lock loop.

19. The antenna radar system of claim 13, wherein by a polarization arrangement using which apertures of the short-range antenna path and the long-range antenna path are cross polarizable.

20. The antenna radar system of claim 14, wherein in a transmit path of the short-range antenna path and of the long-range antenna path there are situated switchable transmit preamplifiers, using which a timed multiplexer is implemented between operation of the short-range antenna path and operation of the long-range antenna path.

21. The antenna radar system of claim 14, wherein by a line network, using which the short-range antenna path and the long-range antenna path are operated synchronously.

22. The antenna radar system of claim 14, wherein by a change-over switch or a multiplexer, using which the short-range antenna path and the long-range antenna path are operated in alternation.

23. A method for operating an antenna radar system comprising:
providing a short-range antenna path and a long-range antenna path situated separately from the short-range antenna path, wherein a push-pull mixer is situated in the short-range antenna path; and
operating the short-range antenna path using heterodyne mixing.

24. The method of claim 23, wherein the heterodyne mixing of the short-range antenna path occurs using a push-pull mixer.

25. The method of claim 23, wherein apertures of the short-range antenna path and of the long-range antenna path are operated cross polarized.

26. The method of claim 23, wherein the transmit path of the short-range antenna path and of the long-range antenna path are operated using a timed multiplexer.
